(19) United States
(12) Patent Application Publication
(10) Pub. No.: US 2019/0182304 A1
(43) Pub. Date: Jun. 13, 2019

(54) UNIVERSAL MESSAGING PROTOCOL FOR LIMITED PAYLOAD SIZE

(71) Applicant: Connect TechNova Inc, San Diego, CA (US)

(72) Inventors: Kenny Fok, San Diego, CA (US); David Diplock, Alpine, CA (US); Niral Bhalodia, San Diego, CA (US); David Chhat, San Diego, CA (US)

(21) Appl. No.: 15/839,183

(22) Filed: Dec. 12, 2017

(51) Int. Cl. H04L 29/06; H04W 4/00; H04L 5/00

(52) U.S. Cl. CPC H04L 65/607; H04L 5/0044; H04W 4/008

(57) ABSTRACT

A streaming media system includes: a source that provides streaming content to a destination across a communication channel, where: the streaming content is sent using a message structure with packets having a first payload size, each packet including at least one streaming payload having a second payload size. An automated method includes: determining a first payload size associated with a communication channel between a source and a destination; determining a second payload size associated with an encoding algorithm used to provide streaming content; determining a maximum number of message types based on the first payload size; and determining a size of an identifier associated with each message. An automated method of providing streaming content includes: receiving streaming content at a source; identifying a message structure; fragmenting the received data based on the message structure; generating an optimized packet using the fragmented data; and sending the optimized packet to a destination.

### BACKGROUND

Many people use electronic devices such as smartphones, tablets, personal computers, etc. to consume streaming data (e.g., multimedia data including audio, video, etc.). User devices may utilize various protocols to receive streamed data wirelessly. Such protocols may not include support for such streaming and may have payload sizes that are no efficient for such usage.

Streaming resources typically encode data for improved compression and the encoded packet size may vary depending on the particular streaming arrangement being used. The size of such encoded packets may not match the payload size of a particular communication protocol and thus may require fragmentation and assembly.

Such fragmentation and assembly typically requires a well-defined message structure that includes a message type and a sequence number. Such identifiers reduce the payload size that is available for data transfer.

Thus there exists a need for an efficient way to fragment and reassembly streaming data while minimizing payload size for identifying information.

### SUMMARY

Some embodiments may provide ways to optimize streaming content based on attributes of available communication channels. Such attributes, include message payload size, streaming payload size, etc. may be analyzed to generate a set of message structures that efficiently utilize the entire message payload size.

A maximum number of message types may be determined based on the number of bytes in a message payload. The number of message types may be used to determine the size needed for a message identification. Such a message identification may be associated with a message structure and a message sequence.

A roster of available message structures may be generated based on the size of the message payload, streaming payload, and message ID. Each message structure may include a message ID, one or more full streaming payloads, a secondary payload, and a tertiary payload (if necessary).

During streaming, incoming streaming data may be fragmented and linked according to the sizes specified by each message structure. The data may then be sent to a destination using the available message structures.

The destination may parse the incoming messages to determine a message ID, and thus, an associated structure. The destination may then fragment the incoming data based on the message structure and assemble complete streaming packets (or identify complete received packets).

The complete streaming packets may then be provided to a player or other appropriate resource for presentation to a user.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a streaming system according to an exemplary embodiment;

FIG. 2 illustrates a data structure diagram of a set of messages used by some embodiments;

FIG. 3 illustrates a flow chart of an exemplary process that defines an optimum messaging arrangement for a given payload and streaming payload;

FIG. 4 illustrates a flow chart of an exemplary server-side process that delivers optimized streaming content to a destination device;

FIG. 5 illustrates a flow chart of an exemplary client-side process that receives optimized streaming content; and

FIG. 6 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a universal messaging protocol for limited payload size.

A first exemplary embodiment may provide a streaming media system comprising: a source device that provides streaming content; and a destination device that receives streaming content from the source device across a communication channel, wherein: the streaming content is sent from the source device to the destination device using a message structure comprising packets having a first payload size, each packet includes an identifier, and each packet includes at least one streaming payload having a second payload size.

A second exemplary embodiment an automated method of generating a message structure comprising a sequence of messages, the method comprising: determining a first payload size associated with a communication channel between a source device and a destination device; determining a second payload size associated with an encoding algorithm used to provide streaming content from the source device to the destination device; determining a maximum number of message types based on the first payload size; and determining a size of a unique identifier associated with each message in the sequence of messages.

A third exemplary embodiment provides an automated method of providing streaming content, the method comprising: receiving streaming content at a source; identifying a message structure comprising a unique identifier, a location of a streaming payload, and a location of at least one partial payload; fragmenting the received data based on the message structure; generating an optimized packet using the fragmented data; and sending the optimized pack to a destination.

Several more detailed embodiments are described in the sections below. Section I provides a description of a system architecture of some embodiments. Section II then describes methods of operation used by some embodiments. Lastly, Section III describes a computer system which implements some of the embodiments.

### I. System Architecture

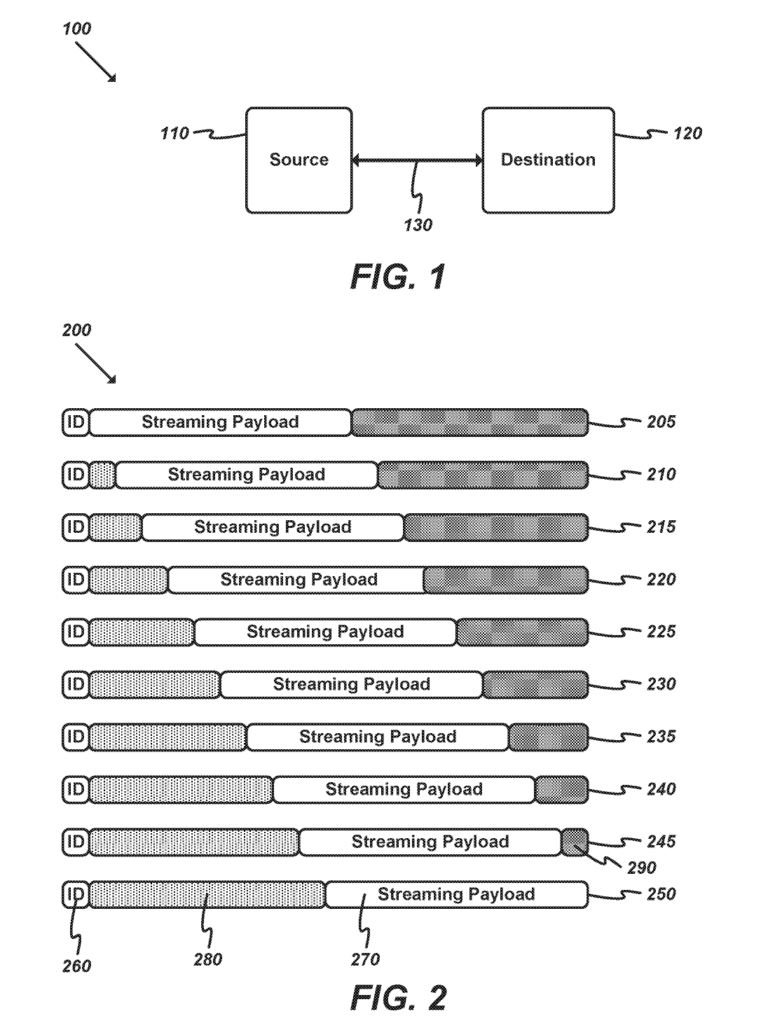

FIG. 1 illustrates a schematic block diagram of a streaming system 100 according to an exemplary embodiment. As shown, the system may include a source 110 and a destination 120 that may communicate across one or more pathways 130.

The source 110 may be an electronic device such as a smartphone, tablet, personal computer, server, storage device, etc. The source may be able to access and/or otherwise communicate with local and/or remote devices such as servers, storages, etc. The source may provide streaming content to the destination device 120.

The destination 120 may be a smartphone, tablet, headphones, personal computer, etc. that may be able to provide streaming content such as audio, video, multimedia, graphics, games, voice over IP (VoIP), etc.

The communication pathway 130 may be a wired (e.g., Ethernet, USB, etc.) and/or wireless channel (e.g., Bluetooth, BLE, Wi-Fi, etc.). The channel may allow for two-way communication between the source 110 and the destination 120. In some embodiments, the channel 130 may allow communication among multiple sources 110 and/or multiple destinations 120.

FIG. 2 illustrates a data structure diagram 200 of a set of messages used by some embodiments. As shown, this arrangement includes ten message types 205-250, each message may include an identifier 260, a streaming payload 270, a secondary payload 280, and, in some cases, a tertiary payload 290.

In this example, the total message 205-250 size is twenty bytes, the streaming payload 270 size is ten bytes, and the message ID 260 size is one byte. The secondary payload 280 (if applicable), and tertiary payload 290 (if applicable) utilize the remaining nine bytes of total message size.

Further, in this example, the messages 205-250 may be sent in a sequence from top to bottom in the diagram 200. In this way, the nine byte tertiary payload of message 205 may be combined with the one byte secondary payload of message 210 in order to form a complete ten byte streaming payload (in addition to the two complete streaming payloads in message 205 and message 210). Likewise, the eight byte tertiary payload of message 210 may be combined with the two byte secondary payload of message 215 and so on until the tertiary byte of message 245 is combined with the secondary byte of message 250, such that a total of nineteen streaming payloads may be sent in this ten message example.

Each identifier 260 may represent both the message type (i.e., distribution of streaming payload, secondary payload, and tertiary payload bytes) and the message sequence (i.e., message one 205 to message ten 250 in this example). The ID 260 may be a fixed number of bytes (one in this example) depending on the number of messages in a sequence.

Each streaming payload 270 may be a fixed size payload (ten bytes in this example) that is associated with a particular streaming protocol. In some embodiments, the total message payload may be large enough to include multiple streaming payloads (e.g., a thirty byte message in this example would include two full streaming payloads in each message, as well as secondary and tertiary payloads, as shown). The streaming payloads are indicated by the clear fill pattern and labels.

Each secondary payload 280 and each tertiary payload 290 may combine to utilize the remaining message bytes (nine in this example). Each secondary payload 280 is indicated by a first fill pattern, while each tertiary payload 290 is indicated by a second fill pattern. In this example, for consistency, the first message 205 is represented as having no secondary payload 280 (or a secondary payload having size zero). Similarly, the last message 250 is represented as having no tertiary payload 290 (or a tertiary payload having size zero). One of ordinary skill in the art will recognize that the secondary and tertiary payloads may alternatively be referred to as “partial” payloads, with the understanding that sequential partial payloads are able to be combined into full streaming payloads.

In this example, one secondary payload 280 is combined with one tertiary payload 290 to generate a full streaming payload. Other embodiments may reduce the size of the streaming payload in some cases (e.g., a fifteen byte message length in this example may not include a full ten byte streaming payload in some messages). As shown, the message sequence may define the relative positions of the streaming payloads 270, secondary payloads 280, and tertiary payloads 290 within each message. In this example, the ID 260 is always the first byte. Different embodiments may arrange the ID and payload in various different ways.

Although the examples above and below may discuss data grouped into “bytes”, different embodiments may be implemented using different such discrete groupings (e.g., using bits, kilobytes, megabytes, etc.). In addition, different embodiments may include different numbers of devices (e.g., sources, destinations, etc.) and/or different interfaces or intermediary devices. For instance, in some embodiments, a “source” may be (and/or may be associated with) an intermediary device that receives streaming content from a server and delivers the content to the destination.

### II. Methods of Operation

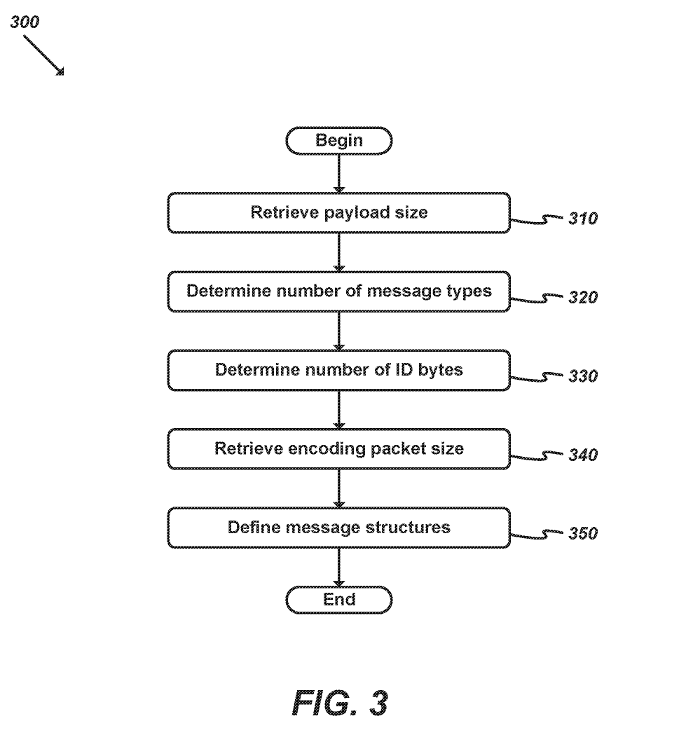

FIG. 3 illustrates a flow chart of an exemplary process 300 that defines an optimum messaging arrangement for a given payload and streaming payload. The process may be performed by a resource such as source 110 described above (and/or other resources such as content servers). The process may begin, for instance, when a request for streaming content is received from a resource such as destination 120.

As shown, the process may then retrieve (at 310) a payload size associated with the current streaming session. Such payload sizes (and/or other relevant parameters) may include, for instance, total message payload size, encoding scheme, etc. The information may be retrieved from an appropriate resource (e.g., a look-up table, a remote server, the source, etc.).

Next, the process may determine (at 320) the maximum number of message types based on the payload sizes. Such a determination may be made using an equation such as equation 1 below.

M=n*(n+1)/2 (1)

Where M is the maximum number of message types and n is the total message payload size.

The process may then determine (at 330) the number of bytes needed for the ID and sequencing portion of the message (e.g., ID and sequence 260 described above) may be calculated using equation 2 below.

B=FLOOR[(⅛)log₂(n*(n+1)/2)] (2)

Where B is the number of bytes needed for the ID and sequencing portion, and n is the total message payload size. Thus, for example, if n equals twenty, there are two hundred ten possible message types and one byte is used to identify them. As another example, if n equals twenty-five, there are three hundred twenty-five potential message types and two bytes are used to represent them. In these examples, bytes are used (thus, the one-eighth factor), but different embodiments may use different units.

Using such an algorithm, various types of encoding schemes may be used (with encoded packet size varying from one to n−1). In addition, representing the sequence number and message structure in a single ID reduces the processing time needed to parse a packet, fragment a packet, re-assemble a packet, and/or handle packet loss.

Next, the process may retrieve (at 340) an encoding packet size. The encoded packet size may be a discrete value between one and n−1, as described above. Various appropriate encoding schemes may be used by different embodiments (e.g., G.729)

The process may then define (at 350) the message structures and associate them with a unique ID and then may end. In the example of FIG. 2 for instance, each ID 260 may be a binary number that increments in value from one to ten over messages 205-250. As the total payload size is twenty and the streaming payload size is ten, there are ten message structures associated with this streaming configuration. If the streaming payload size was twelve bytes, there would be twelve message structures.

The message structures may be defined similar to the structures shown in diagram 200. Thus, for the first message, the ID and one or more complete streaming payloads may be joined. The remaining message payload, if any, may be utilized for a tertiary (or secondary) payload in the first message.

The size of the secondary payload of the second message may then be calculated by determining a difference between the streaming payload size and the size of the tertiary payload in the first message. Again, one or more complete streaming payloads may be added to the ID and secondary payload. The second message may further include a tertiary payload that is calculated by determining the remaining message payload after complete payloads have been added.

From the third message onward, the size of the secondary payload for each message may be calculated by determining a difference between the tertiary payload (if any) size of the previous message and the streaming payload size. This may be repeated until a duplicate message structure is identified and discarded.

More generically, if the tertiary payload size of the previous message is not zero, the size of the secondary payload may be calculated using equation 3 below, while the size of the tertiary payload may be calculated using equation 4 below.

Size(SP_{N})=Size(STRP)−Size(TP_{N-1}) (3)

Size(TP_{N})=n−B−Size(STRP)−Size(SP_{N}) (4)

Where SP_{N} is the secondary payload of the Nth message, STRP is the streaming payload, TP_{N} is the tertiary payload of the Nth message, and TP_{N-1} is the tertiary payload of the previous message (i.e., the message before the Nth message in the sequence). As above, n is the total message payload size and B is the number of bytes needed for the ID and sequencing portion as calculated above using equations (1) and (2).

If the tertiary payload size of the previous message is zero, the size of the secondary payload may be set to zero and the size of the tertiary payload may be calculated using equation 4 above (where size(SP_{N}) is set to zero).

As described above in reference to data structure diagram 200, the messages may be sent in a defined sequence (where position within the sequence is indicated by the message ID). As such, the streaming payloads, secondary payloads, and/or tertiary payloads may be provided in a specified order such that the payloads (and partial payloads) may be provided in the same order as the original streaming content. Thus, for example, the tertiary payload of message 205 may be joined with the secondary payload of message 210 with the information in the secondary payload coming after the information in the tertiary payload when the secondary and tertiary payloads are combined to form a full streaming payload.

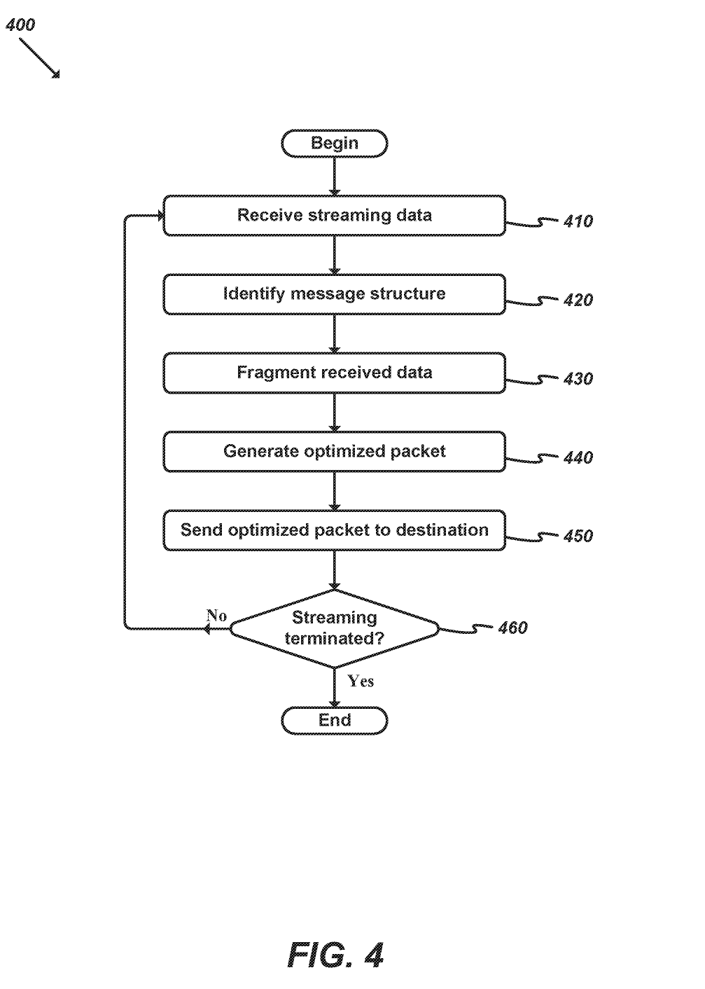

FIG. 4 illustrates a flow chart of an exemplary server-side process 400 that delivers optimized streaming content to a destination device. The process may be performed by a resource such as source 110 described above (and/or other resources such as content servers). Destination 120 may perform a complementary process. Process 400 may begin, for instance, after process 300 has been completed.

As shown, process 400 may receive (at 410) streaming data. Such data may be received from various appropriate resources (e.g., local storage, content servers, etc.). The data may be received over various appropriate connections (e.g., local, wired, wireless, networks, etc.).

Next, the process may identify (at 420) the message structure. The message structure may be identified using a look-up table or other appropriate resource using the results of a process such as process 300. The process 400 may identify a next message to be sent and determine the associated structure (i.e., ID size and position, size and position of streaming payload(s), size and position of secondary and tertiary payloads if needed, etc.).

The process may then fragment (at 430) the received data. Such fragmenting may involve dividing the incoming data to match the sizes specified by the current message structure (whether streaming payload size, secondary payload size, or tertiary payload size). In some embodiments, fragmentation may not be required for all incoming packets (e.g., if an incoming packet size matches a streaming payload size, at least some of the incoming packets may be pass through without fragmentation).

Next, the process may generate (at 440) an optimized packet using the identified message structure. Such generation may include placing the current ID and payloads in the order specified by the message structure. Such payloads may have been previously fragmented (at 430) as necessary, and thus may be linked to form a message of the appropriate structure (and total size).

The process may then send (at 450) the optimized packet to the destination. Such sending may include various intermediary operations (e.g., sending a complete packet to a local storage for queuing). In addition, the source may interact with the destination in various ways before sending any optimized packet. For instance, the source may wait for a request from the destination before sending each packet. As another example, the source may wait for a confirmation that a previous packet was properly received before sending the next packet.

Process 400 may then determine (at 460) whether the streaming session has ended. Such a determination may be made in various appropriate ways (e.g., termination request from the destination, lack of destination response for a specified time, end of streaming content reached, etc.).

If the process determines (at 460) that streaming has not been terminated, the process may repeat operations 410-460 until the process determines (at 460) that streaming has been terminated and then may end.

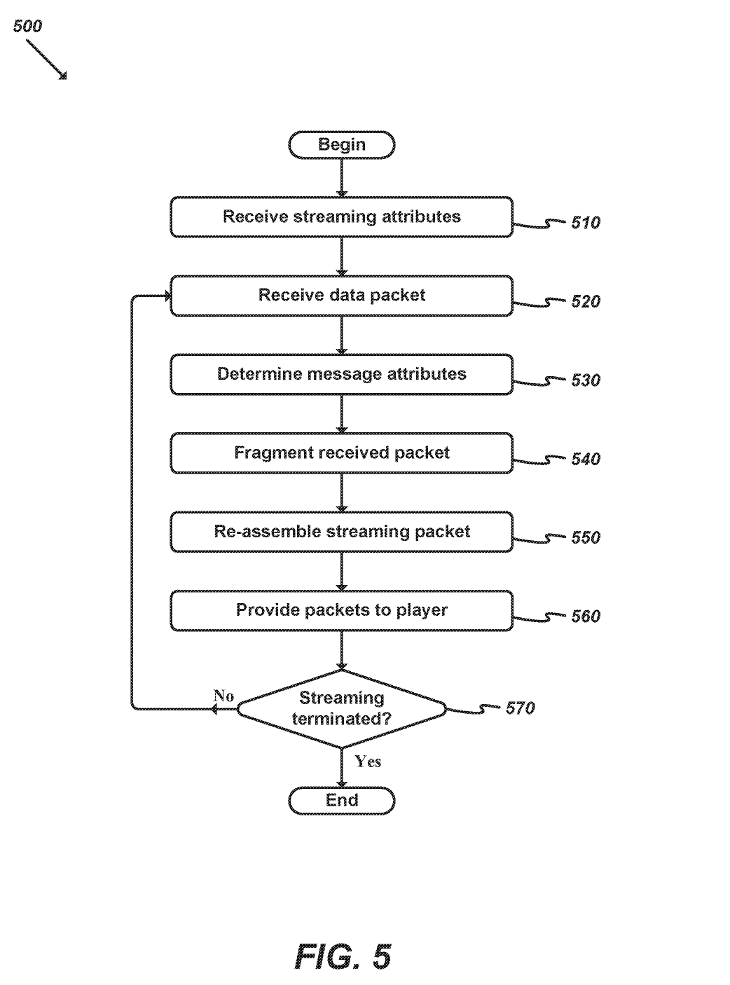

FIG. 5 illustrates a flow chart of an exemplary client-side process 500 that receives optimized streaming content. The process may be performed by a resource such as destination 120 described above (and/or other resources such as content servers). The process may begin, for instance, when a request for streaming content is sent from a resource such as destination 120 to a resource such as source 110. Process 500 may be complementary to process 400.

As shown, process 500 may receive (at 510) attributes for the current streaming session. In some cases, the attributes may be the various payload sizes described above (e.g., total message size, streaming size, etc.). The destination may then perform a process similar to process 300 above in order to identify the various message structures. Alternatively, the received attributes may include a look-up table or other resource that represents the message structures defined by the source.

The process may then receive (at 520) a data packet. Such a data packet may be an optimized packet sent (at 450) above.

Next, process 500 may determine (at 530) the message attributes for the received data packet. Such determination may include, for instance, determining a size and location of a message ID. The message ID may then be used to identify a message structure (including size and location of streaming payload(s), secondary payload, and tertiary payload, if any) using a look-up table or other appropriate resource. Throughout this disclosure, the term “size” may refer to a value that defines a size in bytes (or other appropriate unit) of any particular element. The “location” may refer to a value that defines an absolute position within a message payload. For instance, a message payload having a discrete number of bytes (or other units) may define each location by specifying a starting location for the element (where the starting location may include integer values ranging from a first byte such as the ID byte in the example of chart 200 to a last byte). Thus, in the example of FIG. 2, the bytes may be specified by a size ranging from one to ten and a location ranging from one to twenty.

Process 500 may then fragment (at 540) the received packet based on the payload locations and sizes. Next, the process may re-assemble (at 550) any partial streaming packet(s) included in the message with previously-received partial packets, if available. Any remaining incomplete streaming packets may be set aside until the next message is received.

The process may then provide (at 560) the complete packets to the destination player. Next, the process may determine (at 570) whether the streaming has been terminated. Such a determination may be made in various appropriate ways (e.g., termination request received at the destination, lack of source communication for a specified time, end of streaming content message received, etc.).

If the process determines (at 570) that streaming has not been terminated, the process may repeat operations 520-570 until the process determines (at 570) that streaming has been terminated and then may end.

One of ordinary skill in the art will recognize that the processes described above may be implemented in various different ways without departing from the scope of the disclosure. For instance, the operations may be performed in different orders than shown. As another example, some operations may only be performed based on satisfaction of some specified criteria. As still another example, some operations and/or sets of operations may be performed iteratively. In addition, some embodiments may include additional operations and/or omit various listed operations.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

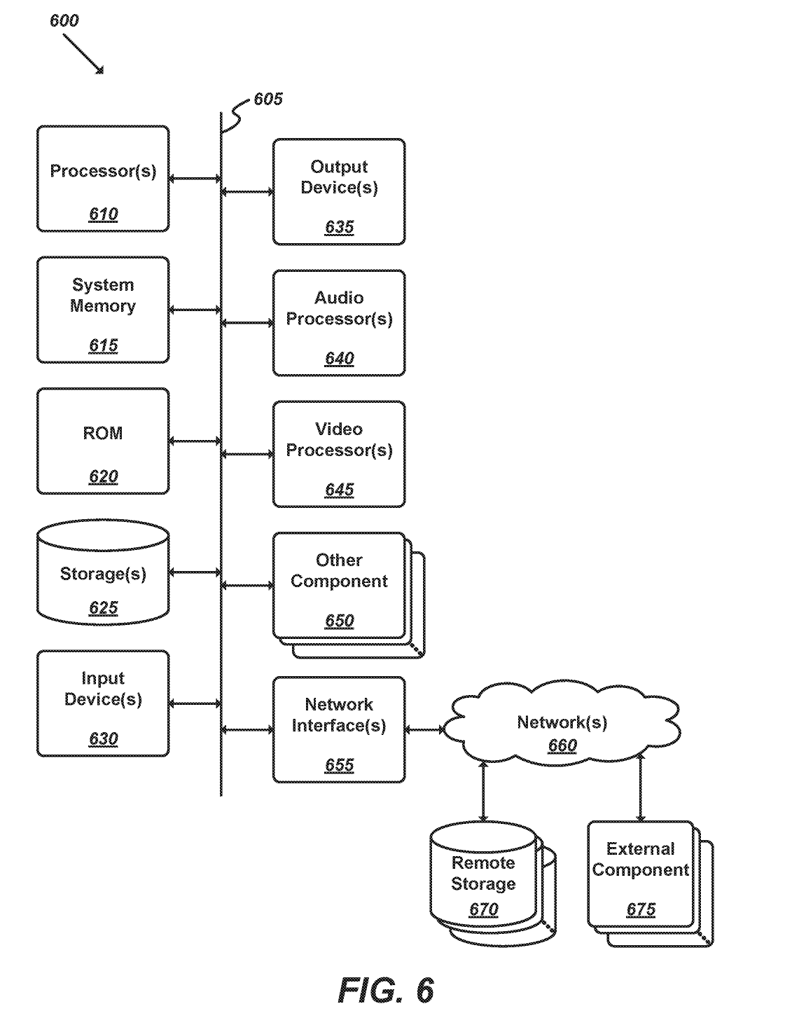

FIG. 6 illustrates a schematic block diagram of an exemplary computer system 600 used to implement some embodiments. For example, the system described above in reference to FIG. 1 may be at least partially implemented using computer system 600. As another example, the processes described in reference to FIG. 3-5 may be at least partially implemented using sets of instructions that are executed using computer system 600.

Computer system 600 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 600 may include at least one communication bus 605, one or more processors 610, a system memory 615, a read-only memory (ROM) 620, permanent storage devices 625, input devices 630, output devices 635, audio processors 640, video processors 645, various other components 650, and one or more network interfaces 655.

Bus 605 represents all communication pathways among the elements of computer system 600. Such pathways may include wired, wireless, optical, and/or other appropriate communication pathways. For example, input devices 630 and/or output devices 635 may be coupled to the system 600 using a wireless connection protocol or system.

The processor 610 may, in order to execute the processes of some embodiments, retrieve instructions to execute and/or data to process from components such as system memory 615, ROM 620, and permanent storage device 625. Such instructions and data may be passed over bus 605.

System memory 615 may be a volatile read-and-write memory, such as a random access memory (RAM). The system memory may store some of the instructions and data that the processor uses at runtime. The sets of instructions and/or data used to implement some embodiments may be stored in the system memory 615, the permanent storage device 625, and/or the read-only memory 620. ROM 620 may store static data and instructions that may be used by processor 610 and/or other elements of the computer system.

Permanent storage device 625 may be a read-and-write memory device. The permanent storage device may be a non-volatile memory unit that stores instructions and data even when computer system 600 is off or unpowered. Computer system 600 may use a removable storage device and/or a remote storage device as the permanent storage device.

Input devices 630 may enable a user to communicate information to the computer system and/or manipulate various operations of the system. The input devices may include keyboards, cursor control devices, audio input devices and/or video input devices. Output devices 635 may include printers, displays, audio devices, etc. Some or all of the input and/or output devices may be wirelessly or optically connected to the computer system 600.

Audio processor 640 may process and/or generate audio data and/or instructions. The audio processor may be able to receive audio data from an input device 630 such as a microphone. The audio processor 640 may be able to provide audio data to output devices 640 such as a set of speakers. The audio data may include digital information and/or analog signals. The audio processor 640 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 645 (or graphics processing unit) may process and/or generate video data and/or instructions. The video processor may be able to receive video data from an input device 630 such as a camera. The video processor 645 may be able to provide video data to an output device 640 such as a display. The video data may include digital information and/or analog signals. The video processor 645 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 650 may perform various other functions including providing storage, interfacing with external systems or components, etc.

Finally, as shown in FIG. 6, computer system 600 may include one or more network interfaces 655 that are able to connect to one or more networks 660. For example, computer system 600 may be coupled to a web server on the Internet such that a web browser executing on computer system 600 may interact with the web server as a user interacts with an interface that operates in the web browser. Computer system 600 may be able to access one or more remote storages 670 and one or more external components 675 through the network interface 655 and network 660. The network interface(s) 655 may include one or more application programming interfaces (APIs) that may allow the computer system 600 to access remote systems and/or storages and also may allow remote systems and/or storages to access computer system 600 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

We claim:

1. A streaming media system comprising:
a source device that provides streaming content; and
a destination device that receives streaming content from the source device across a communication channel,
wherein:
the streaming content is sent from the source device to the destination device using a message structure comprising packets having a first payload size,
each packet includes an identifier, and
each packet includes at least one streaming payload having a second payload size.

2. The streaming media system of claim 1, wherein each packet further includes a secondary payload having a first variable payload size and a tertiary payload having a second variable payload size.

3. The streaming media system of claim 2, wherein the message structure comprises a sequence of messages.

4. The streaming media system of claim 3, wherein each message in the sequence of messages comprises a partial payload.

5. The streaming media system of claim 4, wherein each partial payload is able to be combined with a partial payload from another message to form a complete streaming payload.

6. The streaming media system of claim 1, wherein the communication channel is a Bluetooth low energy (BLE) channel.

7. The streaming media system of claim 1, wherein the first payload size is associated with the communication channel and the second payload size is associated with a particular streaming content encoding algorithm.

8. An automated method of generating a messaging structure comprising a sequence of messages, the method comprising:
determining a first payload size associated with a communication channel between a source device and a destination device;
determining a second payload size associated with an encoding algorithm used to provide streaming content from the source device to the destination device;
determining a maximum number of message types based on the first payload size; and
determining a size of a unique identifier associated with each message in the sequence of messages.

9. The automated method of claim 8 further comprising:
determining a number of messages in the sequence of messages; and
defining a structure for each message in the sequence of messages.

10. The automated method of claim 9, wherein the structure comprises:
the size of the unique identifier and a location of the unique identifier;
a location of a streaming payload having the second payload size; and
a size and location of a partial payload.

11. The automated method of claim 10, wherein the partial payload associated with a particular message from the sequence of messages and the partial payload associated with an adjacent message from the sequence of messages are combined to form a single payload having the second payload size.

12. The automated method of claim 8, wherein the unique identifier is associated with a particular message structure of a particular message from the sequence of messages and a particular location of the particular message within the sequence of messages.

13. The automated method of claim 8, wherein the communication channel comprises Bluetooth low energy (BLE) and the encoding algorithm comprises G.279.

14. The automated method of claim 8, wherein:
determining the maximum number of message types comprises calculating a product of the first payload size and the first payload size plus one and dividing the product by two; and
determining the size of the unique identifier comprises calculating a first value by determining a log base two of the product divided by two, calculating a second value by dividing the first value by eight, and calculating the size of the unique identifier by determining a FLOOR of the second value.

15. An automated method of providing streaming content, the method comprising:
receiving streaming content at a source;
identifying a message structure comprising a unique identifier, a location of a streaming payload, and a location of at least one partial payload;
fragmenting the received data based on the message structure;
generating an optimized packet using the fragmented data; and
sending the optimized packet to a destination.

16. The automated method of claim 15, wherein each partial payload is able to be combined with another partial payload to form additional streaming payloads.

17. The automated method of claim 15, wherein identifying a message structure comprises:
determining the unique identifier of a previous message;
incrementing the unique identifier; and
selecting a particular message structure having the incremented unique identifier.

18. The automated method of claim 17, wherein the message structure is one of a sequence of message structures within a messaging algorithm.

19. The automated method of claim 18, wherein the messaging algorithm comprises a plurality of message structures and a location of each particular message structure within the sequence of message structures is defined by the unique identifier associated with the particular message structure.

20. The automated method of claim 19, wherein the streaming payload has a same size for all message structures within the plurality of message structures.
